(19) United States
(12) Patent Application Publication
(10) Pub. No.: US 2013/0135790 A1
(43) Pub. Date: May 30, 2013

(54) ELECTROCONDUCTIVE POLYMER COMPOSITION, ELECTROCONDUCTIVE POLYMER MATERIAL, ELECTROCONDUCTIVE SUBSTRATE, ELECTRODE AND SOLID ELECTROLYTIC CAPACITOR

(71) Applicant: NEC TOKIN Corporation, Sendai-shi (JP)

(72) Inventors: Yasuhiro TOMIOKA, Sendai-shi (JP); Tomoki NOBUTA, Sendai-shi (JP); Yasuhisa SUGAWARA, Sendai-shi (JP); Satoshi SUZUKI, Sendai-shi (JP)

(73) Assignee: NEC TOKIN Corporation, Sendai-shi (JP)

(21) Appl. No.: 13/675,538

(22) Filed: Nov. 13, 2012

(30) Foreign Application Priority Data
Nov. 25, 2011 (JP) 2011-257654

(51) Int. Cl. H01G 9/042

(52) U.S. Cl. CPC H01G 9/042
USPC 361/523; 252/500; 428/480; 428/474.4; 428/473.5; 428/423.1; 428/523; 428/704; 428/702

(57) ABSTRACT

The problem is to provide an electroconductive polymer composition in which, when a layer containing an electroconductive polymer material is formed, the thickness can arbitrarily be controlled and the layer has a high electroconductivity. The electroconductive polymer composition according to the present invention contains an electroconductive polymer, at least one of water and a water-miscible organic solvent, and a polymer having a urea group as a thickener. By the electroconductive polymer composition according to the present invention, when a layer containing an electroconductive polymer material is formed, the thickness can arbitrarily be controlled even if the amount of a thickener added is made small, and the layer containing an electroconductive polymer material having a high electroconductivity can be formed.

This application is based upon and claims the benefit of priority from Japanese patent application No. 2011-257654, filed on Nov. 25, 2011, the disclosure of which is incorporated herein in its entirety by reference.

### BACKGROUND OF THE INVENTION

1. Field of the Invention

The present invention relates to an electroconductive polymer composition, an electroconductive polymer material, an electroconductive substrate, an electrode and a solid electrolytic capacitor.

2. Description of the Related Art

Electroconductive polymer materials are utilized for transparent electroconductive electrodes of solar cells, organic electroluminescence displays and touch panels, capacitor electrodes, flexible printed circuit boards, and the like.

As the electroconductive polymer material, the polymer materials obtained by polymerizing pyrrole, thiophene, 3,4-ethylenedioxy thiophene, aniline or the like are known. These polymer materials are used as a polymer solution like, for example, a water dispersion of a polythiophene. If the polymer solution is used for producing the electrode or the like, from the viewpoint of the applicability of the polymer solution and of obtaining a applied film with an arbitrary film thickness, it is necessary to control the viscosity of the polymer solution. Thus, the adjustment of the viscosity suitable for each purpose is a problem.

JP 2002-500408 A discloses a paste for screen printing in which a polyacid is doped in a polythiophene. In order to make the viscosity be 1 to 200 dPa·s, a sodium polyacrylate, a methacrylate copolymer, or the like is added as a thickener.

JP 2008-300063 A discloses an electroconductive ink which contains a π-conjugated electroconductive polymer, a polyacid dopant, a thickener and a leveling agent. As the thickener, a chemical compound which contains a glycidyl group and/or a hydroxy group, and one functional group selected from the group consisting of methacryl group, acrylic group, methacryl amide group and acryl amide group.

However, if the thickener disclosed in JP 2002-500408 A or JP 2008-300063 A is used, the amount of the thickener used must become large when the increase of the viscosity is intended for obtaining an applied film with an arbitrary film thickness. It results in the decrease of the electroconductivity of the applied film.

The object of the present invention is to provide an electroconductive polymer composition in which, when a layer containing an electroconductive polymer material is formed, the thickness can arbitrarily be controlled and the layer has a high electroconductivity.

### SUMMARY OF THE INVENTION

The electroconductive polymer composition according to the present invention contains an electroconductive polymer, at least one of water and a water-miscible organic solvent, and a polymer having a urea group as a thickener.

The electroconductive polymer material according to the present invention is obtained by drying the electroconductive polymer composition according to the present invention and by removing at least one of the water and the water-miscible organic solvent.

The electroconductive substrate according to the present invention has a layer containing the electroconductive polymer material according to the present invention on a resin substrate.

The electrode according to the present invention has the electroconductive substrate according to the present invention.

The solid electrolytic capacitor according to the present invention has a solid electrolyte containing the electroconductive polymer material according to the present invention.

According to the present invention, it is possible to provide an electroconductive polymer composition in which, when a layer containing an electroconductive polymer material is formed, the thickness can arbitrarily be controlled and the layer has a high electroconductivity.

### BRIEF DESCRIPTION OF THE DRAWINGS

FIG. 1 is a cross-sectional view showing an example of the solid electrolytic capacitor according to the present invention.

### DETAILED DESCRIPTION OF THE PREFERRED EMBODIMENTS

### Electroconductive Polymer Composition

The electroconductive polymer composition according to the present invention contains an electroconductive polymer, at least one of water and a water-miscible organic solvent, and a polymer having a urea group as a thickener.

In the electroconductive polymer composition according to the present invention, since the electroconductive polymer and the thickener as well as the thickeners themselves are associated to form a three-dimensional network, the viscosity comes to be high even if the thickener is added in a small amount. Thus, when the layer containing an electroconductive polymer material is formed, the thickness can arbitrarily be controlled even if the content of the thickener in the electroconductive polymer composition is made small, and the layer containing an electroconductive polymer material having a high electroconductivity can be formed.

### [Electroconductive Polymer]

The electroconductive polymer is dissolved or dispersed in at least one of water and a water-miscible organic solvent. A π-conjugated electroconductive polymer can be used as the electroconductive polymer according to the present invention, and the examples thereof includes, for example, polymers containing a repeating unit of pyrrole, thiophene, aniline, or the like. Specific examples thereof include polypyrroles, polythiophenes, polyanilines, and the derivatives thereof. In particular, a polymer containing a repeating unit of 3,4-ethylenedioxy thiophene or the derivative thereof is preferable. Specifically, a poly(3,4-ethylenedioxy thiophene) containing a repeating unit represented by following formula (1) or a derivative thereof is preferable.

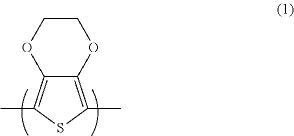

Examples of the derivative of 3,4-ethylenedioxy thiophene include 3,4-(1-alkyl)ethylenedioxy thiophene such as 3,4-(1-hexyl)ethylenedioxy thiophene. The electroconductive polymer may be a homopolymer or may be a copolymer. Also, this electroconductive polymer may be used alone, or may be used in combination with two or more.

The content of the electroconductive polymer in the electroconductive polymer composition is preferably 0.1 parts by mass or more and 30 parts by mass or less with respect to 100 parts by mass of at least one of water and the water-miscible organic solvent that is a solvent, and more preferably 0.5 parts by mass or more and 20 parts by mass or less.

The method for synthesizing the electroconductive polymer according to the present invention is not particularly limited, but the electroconductive polymer can be synthesized by the chemical oxidative polymerization of a monomer providing an electroconductive polymer by using an oxidant in a solvent containing a dopant.

The dopant is not particularly limited, but a sulfonic acid with a low molecular weight or a polyacid is preferably used.

Examples of the sulfonic acid with a low molecular weight include alkyl sulfonic acids, benzenesulfonic acids, naphthalenesulfonic acids, anthraquinone sulfonic acids, camphor sulfonic acids and the derivatives thereof. This sulfonic acid with a low molecular weight may be a monosulfonic acid, a disulfonic acid, or a trisulfonic acid. Examples of the derivative of the alkyl sulfonic acid include 2-acrylamide-2-methylpropanesulfonic acid. Examples of the derivative of the benzenesulfonic acid include phenolsulfonic acid, styrenesulfonic acid, toluenesulfonic acid, and dodecylbenzenesulfonic acid. Examples of the derivative of the naphthalenesulfonic acid include 1-naphthalenesulfonic acid, 2-naphthalenesulfonic acid, 1,3-naphthalenedisulfonic acid, 1,3,6-naphthalenetrisulfonic acid, and 6-ethyl-1-naphthalenesulfonic acid. Examples of the derivative of the anthraquinone sulfonic acid include anthraquinone-1-sulfonic acid, anthraquinone-2-sulfonic acid, anthraquinone-2,6-disulfonic acid, and 2-methylanthraquinone-6-sulfonic acid. Among these, 1-naphthalenesulfonic acid, 2-naphthalenesulfonic acid, 1,3,6-naphthalenetrisulfonic acid, anthraquinone disulfonic acid, p-toluenesulfonic acid, and camphor sulfonic acid are preferable. This sulfonic acid with a low molecular weight may be used alone, or may be used in combination with two or more.

The weight average molecular weight of the sulfonic acid with a low molecular weight is preferably 100 or more and 500 or less. The weight average molecular weight is a value calculated by GPC (gel permeation chromatograph) measurement.

Examples of the polyacid include polycarboxylic acids such as polyacrylic acids, polymethacrylic acids, and polymaleic acids; polysulfonic acids such as polyvinyl sulfonic acids and polystyrene sulfonic acid; and copolymers having a structural unit thereof. Among these, a polystyrene sulfonic acid containing a repeating unit represented by following formula (2) is preferable as a polyacid.

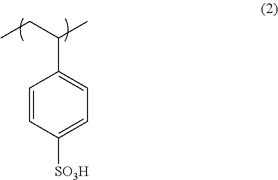

This polyacid may be used alone, or may be used in combination with two or more.

The weight average molecular weight of the polyacid is preferably 2000 or more and 500000 or less, is more preferably 10000 or more and 200000 or less, and is further preferably 30000 or more and 100000 or less. The weight average molecular weight is a value calculated by GPC measurement.

### [Solvent]

The electroconductive polymer composition according to the present invention contains at least one of water and a water-miscible organic solvent as a solvent. The water-miscible organic solvent is not particularly limited as long as it is an organic solvent which is miscible in water, but protic polar solvents such as methanol, ethanol, propanol, and acetic acid, and aprotic polar solvents such as N,N-dimethylformamide, dimethylsulfoxide, acetonitrile, and acetone are preferable. Dimethylsulfoxide is more preferable as the water-miscible organic solvent. This may be used alone, or may be used in combination with two or more.

### [Thickener]

The electroconductive polymer composition according to the present invention contains a polymer having a urea group as a thickener. Since H—N—C=0 and H—N═C—O— are resonated with each other in the polymer having a urea group, strong polarization is generated, and the hydrogen bond between urea groups themselves comes to be easily formed. In particular, since N—H exists at each of both adjacent positions of C=0 in the urea group, it generates a polarization stronger than that of the other functional group and easily generates hydrogen bond between urea groups themselves, and the effect of increasing the viscosity is high. That is, the polymer having a urea group according to the present invention can develop a high effect of increasing the viscosity even if it is added in an amount smaller than that of the other thickener, and can suppress the lowering of the electroconductivity to a minimum.

As a polymer having a urea group as a thickener, polymers containing a diamine unit and a diisocyanate unit can be used. As a commercially-supplied product, for example, BYK-410, BYK-E410, BYK-411, BYK-E411, BYK-420, BYK-E420, BYK-425, BYK-430 and BYK-431 (trade names, made by BYK Japan KK), that are a thickener containing a polymer having a urea group as a main component, can suitably be used. This may be used alone, or may be used in combination with two or more.

The number of the urea groups contained in the polymer having a urea group as a thickener is preferably 2 or more. With the increase of the urea group, a much higher effect of increasing the viscosity can be obtained.

The content of the urea groups contained in the polymer having a urea group as a thickener is preferably 3% by mass or more and 80% by mass or less from the viewpoint of the viscosity. The content is more preferably 5% by mass or more and 50% by mass or less, and is further preferably 6% by mass or more and 30% by mass or less.

The urea group can be qualified and quantified by FTIR (Fourier transform infrared spectrophotometer) and NMR (nuclear magnetic resonance) analyses. Thus, the number of the urea group can be calculated. Also, by measuring the weight average molecular weight of the thickener by GPC, the content of the urea group can be calculated from the number of the urea group calculated by FTIR and NMR, and the weight average molecular weight of the thickener.

The polymer having a urea group as a thickener preferably has a polar functional group at the terminal because the dispersibility and the stability of the electroconductive polymer, which is dissolved or dispersed in at least one of water and a water-miscible organic solvent, can be improved. Here, the polar functional group means a functional group containing an atom whose electronegativity is different from those of carbon atom and hydrogen atom. Examples thereof include nitrogen atom, oxygen atom, fluorine atom, and chlorine atom. As the polar functional group, alkoxy groups such as methoxy group, ethoxy group, propoxy group and butoxy group, hydroxy group, aldehyde group, carboxyl group, and sulfone group are preferable.

The weight average molecular weight of the polymer having a urea group as a thickener is preferably 300 or more and 3000 or less. When the weight average molecular weight is 300 or more, an effect of increasing the viscosity can be obtained. Also, when the weight average molecular weight is 3000 or less, it is suppressed that the thickener inhibits the contact of the electroconductive polymers themselves, and the electroconductivity is improved. The weight average molecular weight is more preferably 500 or more and 2500 or less, and is further preferably 1000 or more and 2000 or less. The weight average molecular weight is a value calculated by GPC measurement.

The content of the polymer having a urea group as a thickener in the electroconductive polymer composition according to the present invention is preferably 0.05% by mass or more and 30% by mass or less. When the content is 0.05% by mass or more, a sufficient effect of increasing the viscosity can be obtained. Also, when the content is 30% by mass or less, the electroconductive path is hardly cut off by the thickener, and the electroconductivity is improved. The content is more preferably 0.1% by mass or more and 25% by mass or less, and is further preferably 1% by mass or more and 20% by mass or less.

### [Binder]

The electroconductive polymer composition according to the present invention preferably contains a binder to improve an adhesion to a resin substrate described below.

As the binder, water-soluble binders such as polyvinyl alcohols, polyacrylic acids, polyacrylamides, polyvinylpyrrolidones, polyesters, polyurethanes, polyamides, and copolymers having a structural unit thereof are preferable. Among these, water-soluble polyesters or polyamides modified by adding a carboxyl group or a sulfo group are preferable from the viewpoint of preserving the dispersion stability of the powder in the electroconductive polymer composition. This may be used alone, or may be used in combination with two or more.

The content of the water-soluble binder in the electroconductive polymer composition according to the present invention is preferably 10 parts by mass or more and 400 parts by mass or less with respect to 100 parts by mass of the electroconductive polymer in the electroconductive polymer composition according to the present invention, and is more preferably 10 parts by mass or more and 100 parts by mass or less. When the content is 10 parts by mass or more, the adhesion is improved. When the content is 400 parts by mass or less, the water resistance is improved.

The electroconductive polymer composition according to the present invention may contain a crosslinker with which the binder is crosslinked.

### (Electroconductive Polymer Material)

The electroconductive polymer material according to the present invention can be obtained by drying the electroconductive polymer composition according to the present invention and by removing at least one of the water and the water-miscible organic solvent. In the electroconductive polymer material according to the present invention, the electroconductive polymer and the thickener are three-dimensionally placed and configured, and it shows a high electroconductivity.

The drying temperature to remove at least one of the water and the water-miscible organic solvent as a solvent is not particularly limited as long as it is a temperature equal to or lower than the decomposition temperature of the electroconductive polymer, but it is preferably 300° C. or lower.

### (Electroconductive Substrate and Electrode)

The electroconductive substrate according to the present invention has a layer (hereinafter, referred to as electroconductive polymer layer) containing the electroconductive polymer material according to the present invention on a resin substrate. Also, the electrode according to the present invention has the electroconductive substrate according to the present invention.

In the electroconductive substrate, the electroconductive polymer layer is formed on at least one side of the resin substrate. The electroconductive substrate is preferably a transparent electroconductive substrate in which the electroconductive polymer layer is formed on at least one side of a transparent resin substrate. As for the method for forming the electroconductive polymer layer, the electroconductive polymer composition according to the present invention may be printed by off-set printing, anastatic printing, intaglio printing, gravure printing, screen printing, ink jet printing, or the like. Also, a thin film may be formed by a spin coating of the electroconductive polymer composition according to the present invention. After that, the electroconductive polymer layer can be formed by drying this to remove at least one of the water and the water-miscible organic solvent that is a solvent. The drying temperature for removing at least one of the water and the water-miscible organic solvent that is a solvent is not particularly limited as long as it is a temperature equal to or lower than the decomposition temperature of the electroconductive polymer as described above, but it is preferably 300° C. or lower.

As the resin substrate, it is preferable to use a transparent resin substrate. Specifically, it preferably contains at least one selected from the group consisting of polyester resins, polyamide resins, polyimide resins, polyurethane resins, polystyrene resins, polyolefin resins, acrylic resins, vinyl ester resins, styrene resins and halogen atom-containing vinyl resins. Also, it may have a layer containing an ITO between the resin substrate and the electroconductive polymer layer.

The electroconductive substrate according to the present invention preferably has a total light transmittance of 80% or more. According to the present invention, the thickness of the electroconductive polymer layer can arbitrarily be adjusted to make the total light transmittance be 80% or more. The total light transmittance is a value measured by using an integrating sphere-type light transmittance measurement device (product name: NDHS5000, made by NIPPON DENSHOKU INDUSTRIES CO., LTD.).

The adjustment of the thickness of the electroconductive polymer layer can be conducted by arbitrarily controlling the viscosity via the amount of the thickener added according to the present invention. Also, thus, a pattern control and a shape control of the electroconductive polymer layer can arbitrarily be conducted.

The electroconductive substrate according to the present invention can be used as an electrode, especially as a transparent electrode. For example, it can be used as a hole-injection layer or a cathode of a solar cell, an organic electroluminescence display, or the like, and also as an electrode of a touch panel, an electronic paper, or the like.

### (Solid Electrolytic Capacitor)

The solid electrolytic capacitor according to the present invention has a solid electrolyte containing the electroconductive polymer material according to the present invention. By the solid electrolyte containing the electroconductive polymer material according to the present invention, a cathode conductor is sufficiently coated with the solid electrolyte. Also, thus, a low ESR can be realized.

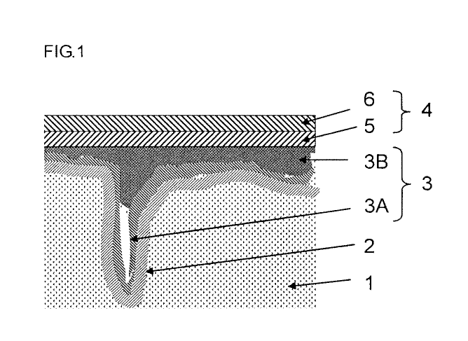

A cross-sectional view of the solid electrolytic capacitor according to the present invention is shown in FIG. 1. In the solid electrolytic capacitor shown in FIG. 1, dielectric layer 2, solid electrolyte layer 3, and cathode conductor 4 are formed in this order on anode conductor 1.

Anode conductor 1 is formed of a plate, a foil or a wire of a metal having valve action, of a sintered body containing metal fine particle having valve action, of a porous body metal subjected to a surface area enlargement treatment by etching; or the like. Examples of the valve action metal include tantalum, aluminum, titanium, niobium and zirconium, and alloys thereof. Among these, the valve action metal is preferably at least one metal selected from the group consisting of tantalum, aluminum and niobium. This may be used alone, or may be used in combination with two or more.

Dielectric layer 2 is a film by electrolytic oxidation of the surface of anode conductor 1 and is also formed on the porous part of the sintered body or the porous body metal. The thickness of dielectric layer 2 can be appropriately adjusted by the voltage of the electrolytic oxidation.

Solid electrolyte layer 3 contains at least the electroconductive polymer material according to the present invention. Solid electrolyte layer 3 may also contain an oxide derivative such as manganese dioxide or ruthenium oxide, or an organic semiconductor such as TCNQ (7,7,8,8-tetracyanoquinodimethane complex salt) as well as the electroconductive polymer material according to the present invention.

The method for forming solid electrolyte layer 3 is not particularly limited, but includes, for example, a method shown below. Solid electrolyte layer 3 is formed by the application or impregnation of the electroconductive polymer composition according to the present invention on dielectric layer 2 formed on the surface of anode conductor 1 and by the drying.

Solid electrolyte layer 3 may contain two or more layers. Examples of the method for forming solid electrolyte layer 3 containing first electroconductive polymer layer 3A and second electroconductive polymer layer 3B which is shown in FIG. 1 includes, for example, a method shown below.

First electroconductive polymer layer 3A is formed by the application or immersion of a monomer, a dopant and an oxidant such as a metal salt or a sulfate on dielectric layer 2 formed on the surface of anode conductor 1 and by chemical oxidative polymerization or electropolymerization thereof. As the monomer, pyrrole, thiophene, aniline and the like can be used. Among these, it is preferable to use the same monomer as the monomer which composes the electroconductive polymer contained in the electroconductive polymer composition used for forming second electroconductive polymer layer 3B described below. That is, in first electroconductive polymer layer 3A and second electroconductive polymer layer 3B, the same electroconductive polymer is preferably used. As the dopant, sulfonic acid compounds such as naphthalenesulfonic acid, benzenesulfonic acid, phenolsulfonic acid, styrenesulfonic acid and the derivatives thereof are preferable. The molecular weight of the dopant can appropriately be selected and used from a monomer to a high molecular weight body.

After that, second electroconductive polymer layer 3B is formed by the application or impregnation of the electroconductive polymer composition according to the present invention on first electroconductive polymer layer 3A and by the drying. The drying temperature to remove the solvent is not particularly limited as long as it is a temperature at which the solvent can be removed. However, from the viewpoint of preventing the element deterioration by heat, it is preferably lower than 300° C. The drying time must appropriately be optimized by the drying temperature, but it is not particularly limited as long as the electroconductivity is not lowered.

It is preferable that first electroconductive polymer layer 3A is completely coated with second electroconductive polymer layer 3B. Thus, solid electrolyte layer 3 and cathode conductor 4 are sufficiently connected with each other, and lower ESR is shown. This coatability depends on the viscosity of the electroconductive polymer composition. The coatability becomes good by raising the viscosity of the electroconductive polymer composition. On the other hand, if the viscosity is too high, the thickness of the layer becomes thick and the shape cannot be controlled. Thus, preferably, the viscosity of the electroconductive polymer composition is appropriately adjusted for use.

Cathode conductor 4 is not particularly limited as long as it is a conductor. For example, it may have a two-layered structure consisting of carbon layer 5 such as graphite and of silver electroconductive resin layer 6.

### EXAMPLES

As follows, the present invention is more concretely explained based on the Examples, but the present invention is not limited to only these Examples.

### Example 1

### Preparation of Electroconductive Polymer Composition

Diphenylmethane-4,4′-diisocyanate and N-methyl-2-pyrrolidone were mixed, and the mixture was heated to 50° C. to dissolve the diisocyanate. Further, a monoamine (methoxy PEG amine with a molecular weight of 800 to 900) which was dissolved in N-methyl-2-pyrrolidone was added and vigorously stirred. The mass ratio of the diisocyanate and the monoamine are 1:7. After that, the temperature was raised up to 170° C., and was maintained at 170° C. for 30 minutes to complete the reaction. Thus, a polyurea having a methoxy group at the terminal with a weight average molecular weight of 2000 and with a content of a urea group of 6% by mass was obtained.

Polystyrene sulfonic acid (5 g) with a weight average molecular weight of 50000, 3,4-ethylenedioxy thiophene (1.25 g) and iron (III) sulfate (0.125 g) were dissolved in water (50 mL). Air was introduced into this solution for 24 hours to produce a polythiophene solution. The synthesized polyurea (weight average molecular weight: 2000, content of urea group: 6% by mass, having a methoxy group at the terminal) (5.0 g) as a thickener was added to 50 g of the polythiophene solution. After that, this solution was stirred at room temperature for 24 hours to dissolve the polyurea in the polythiophene solution. Thus, an electroconductive polymer composition was prepared. The content of the polyurea in the electroconductive polymer composition was 9% by mass. Also, the weight average molecular weight was calculated by GPC measurement.

### <Measurement of Viscosity>

The viscosity of the electroconductive polymer composition was measured by a vibronic viscometer (product name: VM-10A, made by CBC Co., Ltd.). The result is shown in TABLE 1.

### [Production of Electroconductive Substrate]

100 μl of the electroconductive polymer composition was dropped on a resin substrate (total light transmittance: 92%) containing a polyester resin, and a film was formed by a spin coating. The spin coating was conducted at 1000 rpm for 5 seconds and thereafter at 3000 rpm for 30 seconds. After that, the water was volatilized and dried in a thermostatic oven at 125° C. to produce an electroconductive substrate.

### <Measurement of Total Light Transmittance of Electroconductive Substrate>

The total light transmittance of the electroconductive substrate obtained was measured by using an integrating sphere-type light transmittance measurement device (product name: NDH5000, made by NIPPON DENSHOKU INDUSTRIES CO., LTD.). The Result is shown in TABLE 1.

### <Measurement of Film Thickness of Electroconductive Polymer Layer>

The film thickness of the electroconductive polymer layer of the electroconductive substrate obtained was measured by using a light interference-type film thickness measurement device (product name: VM-8000J, made by Dainippon Mfg. Co., Ltd). The Result is shown in TABLE 1.

### <Measurement of Electroconductivity of Electroconductive Polymer Layer>

15 μl of the electroconductive polymer composition was dropped on a glass substrate. The water was volatilized and dried in a thermostatic oven at 125° C. to produce an electroconductive polymer layer with a film thickness of approximately 5 μm. The surface resistance (Ω/□) of the electroconductive polymer layer was measured by using a resistivity meter (product name: Loresta GP, made by Mitsubishi Chemical Analytech Co., Ltd.) whose measurement method was 4-terminal method. Also, the film thickness was measured by using an indicator inspection machine (product name: i-Checker IC1000, made by Mitutoyo Corporation). The electroconductivity (S/cm) was calculated from the surface resistance value and the film thickness. The result is shown in TABLE 1.

### Example 2

An electroconductive polymer composition and an electroconductive substrate were produced in the same manner as in Example 1 except that the synthesized polyurea (weight average molecular weight: 2000, content of urea group: 6% by mass, having a methoxy group at the terminal) (12.0 g) as a thickener was added to 50 g of the polythiophene solution. The content of the polyurea in the electroconductive polymer composition was 19% by mass. Also, the measurements were carried out in the same manner as in Example 1. The Results are shown in TABLE 1.

### Example 3

Diphenylmethane-4,4′-diisocyanate and N-methyl-2-pyrrolidone were mixed, and the mixture was heated to 50° C. to dissolve the diisocyanate. Further, a monoamine (methoxy PEG amine with a molecular weight of 1100 to 1200) and a diamine (PEG diamine with a molecular weight of 1100 to 1200) which were dissolved in N-methyl-2-pyrrolidone were added and vigorously stirred. The mass ratio of the diisocyanate, the monoamine and the diamine are 3:14:7. After that, the temperature was raised up to 170° C. to complete the reaction. Then, a polyurea having a methoxy group at the terminal with a weight average molecular weight of 4000 and with a content of a urea group of 6% by mass was obtained.

An electroconductive polymer composition was produced in the same manner as in Example 1 except that the synthesized polyurea (weight average molecular weight: 4000, content of urea group: 6% by mass, having a methoxy group at the terminal) (5.0 g) as a thickener was added to 50 g of the polythiophene solution. Also, the measurements were carried out in the same manner as in Example 1. The Results are shown in TABLE 1.

### Example 4

Diphenylmethane-4,4′-diisocyanate and N-methyl-2-pyrrolidone were mixed, and the mixture was heated to 50° C. to dissolve the diisocyanate. Further, a monoamine (methoxy PEG amine with a molecular weight of 1800 to 1900) which was dissolved in N-methyl-2-pyrrolidone was added and vigorously stirred. The mass ratio of the diisocyanate and the monoamine are 1:15. After that, the temperature was raised up to 170° C., and was maintained at 170° C. for 30 minutes to complete the reaction. Thus, a polyurea having a methoxy group at the terminal with a weight average molecular weight of 4000 and with a content of a urea group of 3% by mass was obtained.

An electroconductive polymer composition was produced in the same manner as in Example 1 except that the synthesized polyurea (weight average molecular weight: 4000, content of urea group: 3% by mass, having a methoxy group at the terminal) (5.0 g) as a thickener was added to 50 g of the polythiophene solution. Also, the measurements were carried out in the same manner as in Example 1. The Results are shown in TABLE 1.

### Comparative Example 1

An electroconductive polymer composition and an electroconductive substrate were produced in the same manner as in Example 1 except that the thickener was not added to 50 g of the polythiophene solution. Also, the measurements were carried out in the same manner as in Example 1. The Results are shown in TABLE 1. The measurement of film thickness of the electroconductive polymer layer cannot be carried out because of the bad film quality.

### Comparative Example 2

An electroconductive polymer composition and an electroconductive substrate were produced in the same manner as in Example 1 except that glycidyl methacrylate (5.0 g) as a thickener was added to 50 g of the polythiophene solution. Also, the measurements were carried out in the same manner as in Example 1. The Results are shown in TABLE 1. The measurement of film thickness of the electroconductive polymer layer cannot be carried out because of the partial bad film quality.

### Comparative Example 3

An electroconductive polymer composition and an electroconductive substrate were produced in the same manner as in Example 1 except that glycidyl methacrylate (12.0 g) as a thickener was added to 50 g of the polythiophene solution. Also, the measurements were carried out in the same manner as in Example 1. The Results are shown in TABLE 1.

### Example 5

### Production Of Solid Electrolytic Capacitor

A solid electrolytic capacitor shown in FIG. 1 was produced by using the electroconductive polymer composition prepared in Example 1.

A porous aluminum foil of 3×4 mm subjected to a surface area enlargement treatment by etching was used as anode conductor 1. Anode conductor 1 had dielectric layer 2 on the surface. Anode conductor 1 was immersed in a solution which contained a monomer solution containing 3,4-ethylenedioxy thiophene, 1,3,6-naphthalene trisulfonic acid as a dopant, and an oxidant solution containing ammonium peroxodisulfate that was an oxidant. The immersion was repeated several times, and first electroconductive polymer layer 3A containing poly-3,4-ethylenedioxy thiophene was formed by chemical oxidative polymerization method. Then, it was immersed in the electroconductive polymer composition prepared in Example 1. This was dried and solidified in a thermostatic oven at 125° C. to form second electroconductive polymer layer 3B on first electroconductive polymer layer 3A. After that, graphite layer 5 and silver electroconductive resin layer 6 were sequentially formed on second electroconductive polymer layer 3B to produce a solid electrolytic capacitor.

### <Evaluation of the Coatability of Second Electroconductive Polymer Layer 3B>

After second electroconductive polymer layer 3B was formed, the coatability of second electroconductive polymer layer 3B was checked and evaluated by using an optical microscope (product name: digital microscope VHX-100F, made by KEYENCE CORPORATION). The evaluation criteria are as follows. Also, the evaluation result is shown in TABLE 2.

A: First electroconductive polymer layer 3A is completely coated with second electroconductive polymer layer 3B.
B: There is an area in which first electroconductive polymer layer 3A is not coated with second electroconductive polymer layer 3B.

### <ESR Measurement>

The ESR of the solid electrolytic capacitor produced was measured at a frequency of 100 kHz by using an LCR meter. The result is shown in TABLE 2.

### Example 6

A solid electrolytic capacitor was produced in the same manner as in Example 5 except that the electroconductive polymer composition prepared in Example 3 was used for the formation of second electroconductive polymer layer 3B, and the evaluation and the measurement were carried out. The results are shown in TABLE 2.

### Comparative Example 4

A solid electrolytic capacitor was produced in the same manner as in Example 5 except that the electroconductive polymer composition prepared in Comparative Example 1 was used for the formation of second electroconductive polymer layer 3B, and the evaluation and the measurement were carried out. The results are shown in TABLE 2.

### Comparative Example 5

A solid electrolytic capacitor was produced in the same manner as in Example 5 except that the electroconductive polymer composition prepared in Comparative Example 2 was used for the formation of second electroconductive polymer layer 3B, and the evaluation and the measurement were carried out. The results are shown in TABLE 2.

### Comparative Example 6

A solid electrolytic capacitor was produced in the same manner as in Example 5 except that the electroconductive polymer composition prepared in Comparative Example 3 was used for the formation of second electroconductive polymer layer 3B, and the evaluation and the measurement were carried out. The results are shown in TABLE 2.

TABLE 1

| | | total light | film | electro- |
|---|---|---|---|---|
| | viscosity | transmit- | thickness | conductivity |
| | (mPa · s) | tance (%) | (nm) | (S/cm) |
| Ex. 1 | 115 | 87 | 100 | 95 |
| Ex. 2 | 500 | 85 | 200 | 70 |
| Ex. 3 | 115 | 87 | 100 | 90 |
| Ex. 4 | 60 | 87 | 80 | 95 |
| Comp. Ex. 1 | 10 | 90 (bad | unmeasurable | 95 |
| | | film quality) | | |
| Comp. Ex. 2 | 30 | 87 | unmeasurable | 91 |
| Comp. Ex. 3 | 120 | 85 | 100 | 50 |

TABLE 2

| | coatability | ESR (mΩ · cm²) |
|---|---|---|
| Ex. 5 | A | 3.5 |
| Ex. 6 | A | 3.8 |
| Comp. Ex. 4 | B | 8.5 |
| Comp. Ex. 5 | B | 6.5 |
| Comp. Ex. 6 | A | 12.5 |

From TABLE 1, although the content of the thickener was the same between Examples 1, 3 and 4, and Comparative Example 2 and between Example 2 and Comparative example 3, respectively, the high viscosity could be obtained in Examples 1 to 4 in which a polymer having a urea group that was the thickener according to the present invention was used. This is thought to be because a network structure of the thickener is formed by the hydrogen bond between the urea groups, the molecular weight spuriously becomes high, and a high effect of increasing the viscosity can be obtained by a small amount of the thickener. From this, it has been found that, by using the polymer having a urea group according to the present invention as the thickener, the viscosity of the electroconductive polymer composition can be adjusted by a small amount of the thickener, and the shape control of the electroconductive polymer layer becomes easy.

Also, the total light transmittances of the electroconductive substrates in Examples 1 to 4 were 80% or more, and when the polymer having a urea group that was the thickener according to the present invention was used, the high total light transmittance was shown. Further, although the spin coating was conducted under the same condition in the formation of the electroconductive substrate in Examples 1 and 2, the film thickness was 100 nm in Example 1 and 200 nm in Example 2, and the increase of the film thickness was observed with the increase of the viscosity. From this, it has been found that, by adjusting the viscosity by the amount of the thickener added, the film thickness can easily be controlled. Also, in Example 1, the higher viscosity than that in Example 4 could be obtained. It is because the content of the urea group in the thickener of Example 1 is more than that of Example 4 and because a high effect of increasing the viscosity can be obtained in Example 1.

On the other hand, in Comparative Examples 1 and 2, the viscosity of the electroconductive polymer composition was low, and the electroconductive polymer composition was not uniformly left on the resin substrate by a spin coat. Thus, an electroconductive polymer layer was not obtained in Comparative Example 1, and an electroconductive polymer layer having a partly non-uniform thickness was obtained in Comparative Example 2. In Comparative Example 3 in which the amount of the thickener added was increased, an electroconductive polymer layer with a thickness of 100 nm was obtained, but the total light transmittance was slightly lowered in comparison with Example 1 in which the thickness was the same because the amount of the thickener added was large.

As for the electroconductivity, from Examples 1 to 4, it has been found that the high electroconductivity is obtained when a polymer having a urea group as the thickener according to the present invention is used. Also, in the case in which the viscosity and the electroconductivity of Example 1 were compared with those of Comparative Example 3, the viscosities of Example 1 and Comparative Example 3 were equal, but the higher electroconductivity of Example 1 than that of Comparative Example 3 was obtained. This is because the desired viscosity can be obtained also by a small amount of the thickener in Example 1 in which the thickener according to the present invention was used, while a large amount of the thickener must be used for obtaining the desired viscosity in Comparative Example 3. Also, from the result that the electroconductivity in Example 1 is higher than that of Example 3, it has been found that, when the molecular weight of the thickener according to the present invention is 3000 or less, it is suppressed that the thickener inhibits the contact of the electroconductive polymers themselves, the conduction path is ensured, and the electroconductivity is more improved.

From TABLE 2, the higher coatabilities were shown in Examples 5 and 6 than those of Comparative Examples 4 and 5. It is recognized that this result is close to the viscosity values of the electroconductive polymer composition in TABLE 1. Also, the lower ESRs were shown in Examples 5 and 6 than those of Comparative Examples 4 and 5. This is thought to be because the contact of solid electrolyte layer 3 and cathode conductor 4 is good because of the excellent coatabilities in Examples 5 and 6. Further, the lower ESRs were shown in Examples 5 and 6 than that of Comparative Example 6. This is thought to be because the electroconductivities of Examples 1 and 3 which correspond to Examples 5 and 6 are higher than the electroconductivity of Comparative Example 3 which corresponds to Comparative Example 6.

As just described, by using a polymer having a urea group that is the thickener according to the present invention, the desired viscosity can be obtained by a small amount of the thickener, and the film thickness and the shape of the electroconductive polymer layer can easily be controlled. Also, since a sufficient effect of increasing the viscosity can be obtained by a small amount of the thickener according to the present invention, the electroconductivity of the electroconductive polymer material is improved and the higher electroconductivity is shown. Further, an electroconductive substrate and an electrode with a desired film thickness as well as a solid electrolytic capacitor with an excellent coatability and a low ESR can be provided.

The present invention can be utilized for electrodes of solar cells, organic electroluminescence displays, touch panels and the like as well as solid electrolytic capacitors.

What is claimed is:

1. An electroconductive polymer composition, comprising an electroconductive polymer, at least one of water and a water-miscible organic solvent, and a polymer having a urea group as a thickener.

2. The electroconductive polymer composition according to claim 1, wherein a weight average molecular weight of the polymer having a urea group is 300 or more and 3000 or less.

3. The electroconductive polymer composition according to claim 1, wherein a content of the polymer having a urea group is 0.05% by mass or more and 30% by mass or less.

4. The electroconductive polymer composition according to claim 1, wherein a content of the urea group in the polymer having a urea group is 3% by mass or more and 80% by mass or less.

5. The electroconductive polymer composition according to claim 1, wherein the polymer having a urea group has a functional group showing a polarity at a terminal thereof.

6. The electroconductive polymer composition according to claim 1, wherein the electroconductive polymer is a polymer having a repeating unit of 3,4-ethylenedioxy thiophene or a derivative thereof and wherein the composition further comprises a polyacid.

7. The electroconductive polymer composition according to claim 6, wherein the polyacid is a polystyrene sulfonic acid.

8. The electroconductive polymer composition according to claim 6, wherein a weight average molecular weight of the polyacid is 2000 or more and 500000 or less.

9. An electroconductive polymer material, obtained by drying the electroconductive polymer composition according to claim 1 and by removing at least one of the water and the water-miscible organic solvent.

10. An electroconductive substrate, which comprises a layer comprising the electroconductive polymer material according to claim 9 on a resin substrate.

11. The electroconductive substrate according to claim 10, having a total light transmittance of 80% or more.

12. The electroconductive substrate according to claim 10, wherein the resin substrate comprises at least one selected from the group consisting of polyester resins, polyamide resins, polyimide resins, polyurethane resins, polystyrene resins, polyolefin resins, acrylic resins, vinylester resins, styrene resins and halogen atom-containing vinyl resins.

13. The electroconductive substrate according to claim 10, which comprises a layer comprising an ITO between the resin substrate and the layer comprising the electroconductive polymer material.

14. An electrode, comprising the electroconductive substrate according to claim 10.

15. A solid electrolytic capacitor, which comprises a solid electrolyte comprising the electroconductive polymer material according to claim 9.
